(19) United States
(12) Patent Application Publication
(10) Pub. No.: US 2026/0112676 A1
(43) Pub. Date: Apr. 23, 2026

(54) COMPRESSION SYSTEMS FOR ELECTROCHEMICAL STACKS

(71) Applicant: ELECTRIC HYDROGEN CO., Devens, MA (US)

(72) Inventors: Aravind Kandaswami, Belmont, MA (US); Asher Solnit, Atlanta, GA (US); Richard Liebert, Brookline, MA (US)

(21) Appl. No.: 19/156,671

(22) PCT Filed: Apr. 22, 2025
(86) PCT No.: PCT/US2025/025831

§ 371 Date: Aug. 14, 2025

Related U.S. Application Data
(60) Provisional application No. 63/645,304, filed on May 10, 2024.

(51) Int. Cl. H01M 8/248; H01M 8/04664; H01M 8/2475

(52) U.S. Cl. CPC H01M 8/248; H01M 8/2475; H01M 8/04679

(57) ABSTRACT

A system and method of actively managing electrochemical stack compression using a hybrid compression system is provided. The method includes: receiving, by a data acquisition unit, stack data from an electrochemical stack in real time; providing, by the data acquisition unit, the stack data to a first compression controller and to a second compression controller; controlling, by the first compression controller, a first compression system configured to provide first adjustments to a compression force applied to the electrochemical stack; and controlling, by the second compression controller, a second compression system configured to provide second adjustments to the compression force on the electrochemical stack. The first compression system may be configured to provide the first adjustments to the compressive force during start-up and/or shutdown of the electrochemical stack. The second compression system may be configured to provide the second adjustments during the steady-state operation of the electrochemical stack.

WO

This application claims the benefit of U.S. Provisional Ser. No. 63/645,304, filed May 10, 2024, which is hereby incorporated by reference in its entirety.

### FIELD

The following disclosure relates to electrochemical devices, systems, and components thereof. More specifically, the following disclosure relates to managing (e.g., in real-time or periodically) the compression of a stacked fluidic device such as an electrochemical stack via one or more compression systems.

### BACKGROUND

Hydrogen has been considered as an ideal energy carrier to store renewable energy. Proton exchange membrane water electrolysis (PEMWE) as a means for hydrogen production offers high product purity, fast load response times, small footprints, high efficiencies, and low maintenance efforts. It is regarded as a promising technology, especially when coupled with renewable energy sources.

An electrolysis cell or system uses electrical energy to drive a chemical reaction. For example, water is split to form hydrogen and oxygen. The products may be used as energy sources for later use. In recent years, improvements in operational efficiency have made electrochemical systems competitive market solutions for energy storage, generation, and/or transport. For example, the cost of generation may be below $6 per kilogram of hydrogen in some cases. Increases in efficiency and/or improvements in operation will continue to drive the installation of electrochemical systems.

### SUMMARY

In one embodiment, a hybrid compression system for an electrochemical stack having a plurality of electrochemical cells is provided. The hybrid compression system may include a first compression system configured to provide first adjustments to a compression force applied to the electrochemical stack such as to compress or decompress the electrochemical stack. The first compression system may include: (1) a plurality of hydraulic cylinders or a plurality of pneumatic cylinders; and (2) at least one pressure source or hydraulic reservoir in communication with the plurality of hydraulic cylinders or the plurality of pneumatic cylinders. The hybrid compression system may also include a second compression system configured to provide second adjustments to the compression force on the electrochemical stack. The first compression system may be configured to provide the first adjustments to the compressive force during start-up and/or shutdown of the electrochemical stack. The first compression system may be configured to disengage from providing the first adjustments during a steady-state operation of the electrochemical stack. The second compression system may be configured to provide the second adjustments during the steady-state operation of the electrochemical stack.

In another embodiment, a method of actively managing an electrochemical stack compression with a hybrid compression system including a first compression system and a second compression system is provided. The method includes: providing, by the first compression system, first adjustments to a compression force applied to an electrochemical stack of an electrochemical system such as to compress and/or decompress the electrochemical stack during a start-up of the electrochemical stack, wherein the first compression system includes: (1) a plurality of hydraulic cylinders, or a plurality of pneumatic cylinders, and (2) at least one pressure source or hydraulic reservoir in communication with the plurality of hydraulic cylinders, or the plurality of pneumatic cylinders; disengaging the first compression system from providing the first adjustments after the electrochemical system has reached a predefined steady-state operation; receiving, by a data acquisition unit of the electrochemical system, stack data in real time from the electrochemical stack of the electrochemical system; and providing, by a second compression system separate from the first compression system, second adjustments to the compression force on the electrochemical stack during the steady-state operation of the electrochemical stack.

In another embodiment, an additional method of actively managing an electrochemical stack compression with a hybrid compression system including a first compression system and a second compression system is provided. The method includes: receiving, by a data acquisition unit of an electrochemical system, stack data in real time from an electrochemical stack of the electrochemical system; providing, by the second compression system, adjustments to a compression force on the electrochemical stack during a predefined steady-state operation of the electrochemical stack; engaging the first compression system that is separate from the second compression system when the electrochemical system has received instructions for a shutdown of the electrochemical stack, wherein the first compression system includes: (1) a plurality of hydraulic cylinders, or a plurality of pneumatic cylinders, and (2) at least one pressure source or hydraulic reservoir in communication with the plurality of hydraulic cylinders, or the plurality of pneumatic cylinders; and providing, by the first compression system, adjustments to a compression force applied to an electrochemical stack of an electrochemical system such as to compress and/or decompress the electrochemical stack during the shutdown of the electrochemical stack.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Exemplary embodiments are described herein with reference to the following drawings.

FIG. 1 depicts an example of an electrochemical cell.

FIG. 2 depicts an example of various layers within an electrochemical cell.

FIG. 3 depicts an example of a section of a system having an electrochemical stack.

FIG. 4 depicts a sectional view of an example of a hybrid compression system for actively controlling stack compression.

FIG. 5 depicts an example of a second compression system of a hybrid compression system depicted in FIG. 4.

FIG. 6 depicts an example of a second compression system including a plurality of engagement mechanisms.

FIG. 7 depicts an exploded perspective view of a second compression system including a plurality of engagement mechanisms.

FIG. 8 depicts an example method for actively controlling stack compression using a hybrid compression system.

FIG. 9 depicts an example method for recompressing an electrochemical stack during steady-state operation of an electrochemical system using a hybrid compression system.

FIG. 10 depicts an example method for decompressing an electrochemical stack during a ramp-down operation of an electrochemical system using a hybrid compression system.

FIG. 11 depicts an example communication system between an electrochemical stack and a computing device having a controller over a connected network.

FIG. 12 depicts an example of a computing device having a controller.

While the disclosed compositions and methods are representative of embodiments in various forms, specific embodiments are illustrated in the drawings (and are hereafter described), with the understanding that the disclosure is intended to be illustrative and is not intended to limit the claim scope to the specific embodiments described and illustrated herein.

### DETAILED DESCRIPTION

While the following description primarily relates to electrolysis cell stacks and systems, the improved mechanisms, devices, systems, and methods disclosed herein may also be applicable to other stacked fluidic cell devices and systems (such as fuel cells). In other words, the improvements disclosed herein, while discussed with relation to an electrolysis cell stack or system may also be applicable to a fuel cell stack or system and should not be construed as limited to one or the other.

An electrochemical or electrolysis system may include one or more electrochemical stacks, wherein each stack is made up of a plurality of individual electrolytic cells. The discussed architectures and techniques may support the management of the compression of electrochemical stacks in real time during operation of the electrochemical stack/system. Each stack may be independently connected to power electronics, water, and gas systems. In some cases, a subgroup of electrochemical stacks may be coupled together through one or more mechanisms. In some cases, each stack and/or sub-group may be compressed independently using a separate support structure. In other cases, each stack and/or sub-group may be compressed in unison using the same support structure.

In some cases, the compression of an electrochemical stack is actively managed during the operation and life cycle of an electrochemical system in order to maintain optimal membrane electrode assembly (MEA), electrical contact resistance, and/or seal compression. In some cases, the compression of an electrochemical stack is varied during the operation and the lifetime of the stack to maintain MEA compression, minimize electrical contact resistance, and/or extend seal life. In addition, because electrochemical stacks may operate through a range of temperatures and incorporate thermally mismatched materials, provisions are needed for thermal expansion mismatch between a structure providing compression and the electrochemical stack.

Additionally, electrochemical stacks may require precision machined flat end plates that are extremely stiff in order to provide uniform compression of the stack components (e.g., flow plates, conducting transfer layers, seals, and membrane). The tolerances in such systems are extremely tight, and the resulting end plates (e.g., fluid manifolds) are extremely thick, heavy, and costly. The problem is exasperated as the size (area) of the electrochemical stack increases.

### Electrochemical Cells and Stacks

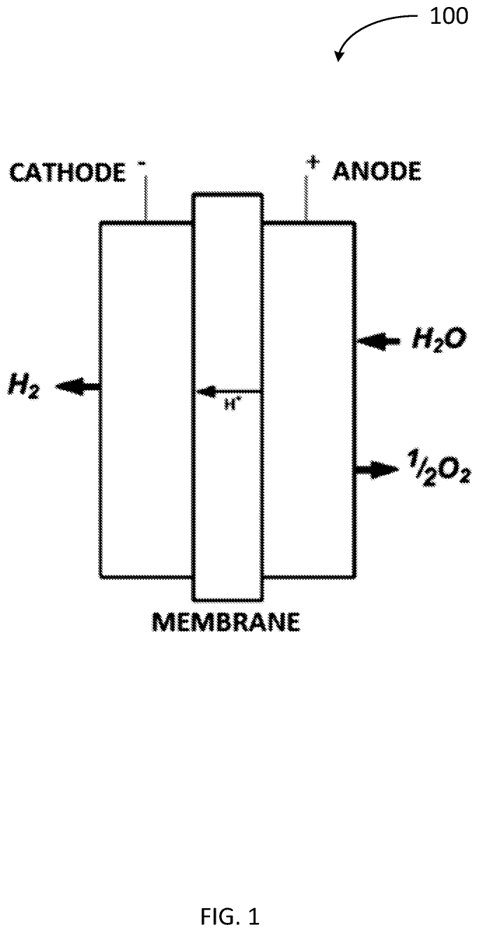

FIG. 1 depicts an example of an electrolytic cell for the production of hydrogen gas and oxygen gas through the splitting of water. The electrolytic cell includes a cathode, an anode, and a membrane positioned between the cathode and anode. The membrane may be a proton exchange membrane (PEM). Proton Exchange Membrane (PEM) electrolysis involves the use of a solid electrolyte or ion exchange membrane. Within the water splitting electrolysis reaction, one interface runs an oxygen evolution reaction (OER) while the other interface runs a hydrogen evolution reaction (HER). For example, the anode reaction is H₂O→2H⁺+½O₂+2e and the cathode reaction is 2H⁺+2e→H₂. The water electrolysis reaction has recently assumed significant importance and renewed attention as a potential foundation for a decarbonized “hydrogen economy.”

Because the performance of a single electrolytic cell may not be adequate for many use cases, multiple electrolytic cells may be placed together to form a “stack” of electrolytic cells, which may be referred to as an electrochemical stack, electrolytic stack, or electrochemical stack. In one example, an electrochemical stack may contain 50-1000 cells, 50-100 cells, 500-700 cells, or more than 1000 cells. Any number of cells may make up an electrochemical stack. The electrochemical cells within the electrochemical stack may be configured to operate with 200 mV or less of pure resistive loss when operating at a high current density (e.g., at least 3 Amps/cm², at least 4 Amps/cm², at least 5 Amps/cm², at least 6 Amps/cm², at least 7 Amps/cm², at least 8 Amps/cm², at least 9 Amps/cm², at least 10 Amps/cm², at least 11 Amps/cm², at least 12 Amps/cm², at least 13 Amps/cm², at least 14 Amps/cm², at least 15 Amps/cm², at least 16 Amps/cm², at least 17 Amps/cm², at least 18 Amps/cm², at least 19 Amps/cm², at least 20 Amps/cm², at least 25 Amps/cm², at least 30 Amps/cm², in a range of 1-30 Amps/cm², in a range of 3-20 Amps/cm², in a range of 3-15 Amps/cm², in a range of 3-10 Amps/cm², or in a range of 10-20 Amps/cm²).

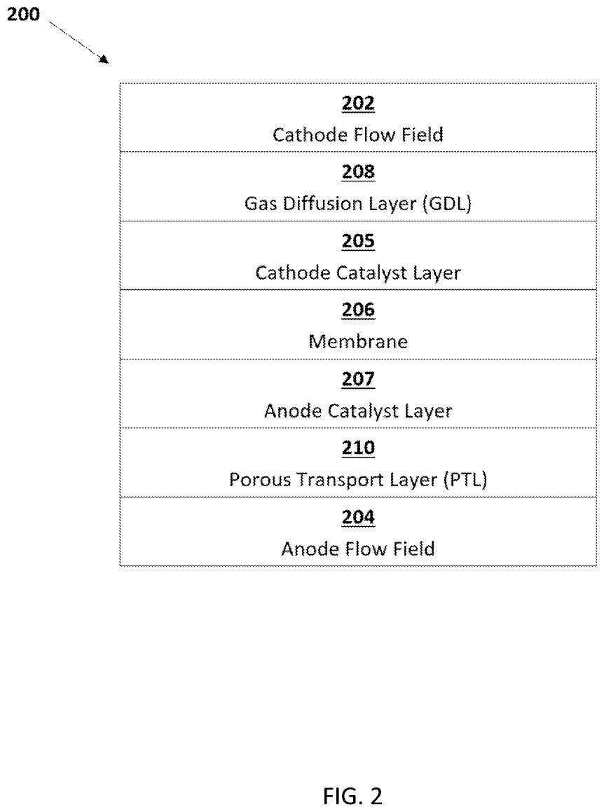

FIG. 2 depicts an additional example of an electrochemical or electrolytic cell 200. Specifically, FIG. 2 depicts a portion of an electrochemical cell 200 having a cathode flow field 202, an anode flow field 204, and a membrane 206 positioned between the cathode flow field 202 and the anode flow field 204. In certain examples, the membrane 206 may have an overall thickness that is less than 1000 microns, 500 microns, 100 microns, 50 microns, 10 microns, etc.

In certain examples, additional layers may be present within the electrochemical cell 200. For example, one or more additional layers 208 may be positioned between the cathode flow field 202 and membrane 206. In certain examples, this may include a gas diffusion layer (GDL) 208 may be positioned between the cathode flow field 202 and membrane 206. This may be advantageous in providing a hydrogen diffusion barrier adjacent to the cathode on one side of the multi-layered membrane to mitigate hydrogen crossover to the anode side. In other words, the GDL is responsible for the transport of gaseous hydrogen to the cathode side flow field. For a wet cathode PEM operation, liquid water transport across the GDL is needed for heat removal in addition to heat removal from the anode side.

Similarly, one or more additional layers 210 may be present in the electrochemical cell between the membrane 206 and the anode flow field 204. In certain examples, this may include a porous transport layer (PTL) positioned between the membrane 106 (e.g., the anode catalyst layer 207 of the catalyst coated membrane 206) and the anode flow field 204.

Similar to the GDL, the PTL is configured to allow the transportation of the reactant water to the anode catalyst layers, remove produced oxygen gas, and provide good electrical conductivity for effective electron conduction. In other words, liquid water flowing in the anode flow field is configured to permeate through the PTL to reach the CCM. Further, gaseous byproduct oxygen is configured to be removed from the PTL to the flow fields. In such an arrangement, liquid water functions as both reactant and coolant on the anode side of the cell.

In some examples, an anode catalyst coating layer may be positioned between the anode flow field 204 and the PTL.

The cathode flow field 202 and anode flow field 204 of the cell may individually include a flow field plate composed of metal, carbon, or a composite material having a set of channels machined, stamped, or etched into the plate to allow fluids to flow inward toward the membrane or out of the cell.

Since the performance of a single electrolytic cell may not be adequate for many use cases, multiple cells may be placed together to form a “stack” of cells, which may be referred to as an electrochemical stack, electrolytic stack, electrochemical stack, or simply just a stack. In one example, a stack may contain 50-1000 cells, 50-100 cells, 500-700 cells, or more than 1000 cells. Any number of cells may make up a stack.

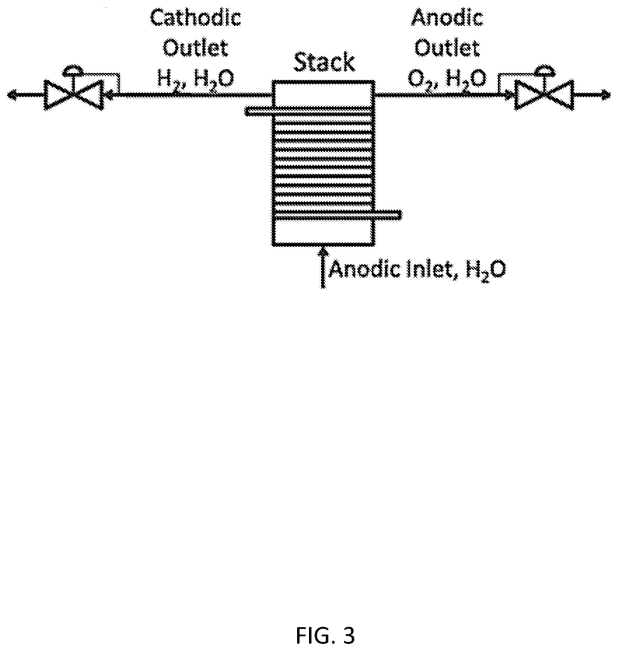

FIG. 3 depicts an example of a portion of electrolysis system for producing hydrogen gas and oxygen gas from water. The system includes a stack including a plurality of electrochemical or electrolytic cells, such as the cell of FIG. 1 or FIG. 2. The stack is configured to receive water through an anodic inlet. The system further includes a cathodic outlet at an outlet of the stack. The cathodic outlet transfers the hydrogen gas produced from the electrolytic cells to further downstream components for further processing.

In embodiments where water is supplied to the cathode inlet, water supplied to the cathode inlet flows to a cathodic inlet manifold that distributes the water to the cathode side of the plurality of cells in the electrochemical stack (wherein the water may be used as a coolant for the hydrogen gas produced). In certain examples, the amount of water (e.g., deionized (DI) water) transferred to or circulated through each cell of the electrochemical stack may be less than 5 mL/Amp/cell/min, less than 1 mL/Amp/cell/min, less than 0.5 mL/Amp/cell/min, less than 0.1 mL/Amp/cell/min, less than 0.05 mL/Amp/cell/min. In other examples, the amount of water transferred to or circulated through each cell of the stack may be in a range of 0.05-0.1 mL/Amp/cell/min, 0.05-0.25 mL/Amp/cell/min, 0.05-0.5 mL/Amp/cell/min, 0.05-1 mL/Amp/cell/min, 0.05-5 mL/Amp/cell/min, 0.1-1 mL/Amp/cell/min, 0.1-5 mL/Amp/cell/min, 0.25-1 mL/Amp/cell/min, in a range of 0.25-5 mL/Amp/cell/min, or in a range of 0.5-1 mL/Amp/cell/min.

Additional downstream components following the cathodic outlet are not depicted, but may include water-gas separators, purifiers, heat exchangers, circulation pumps, pressure regulators, etc.

In FIG. 3, a cathodic pressure regulator is depicted at the cathodic outlet. This pressure regulator may be positioned further downstream from the cathodic outlet after one or more further components such as a water-gas separator or purifier but is depicted at the particular location in FIG. 3 for simplicity.

Further, the electrolysis system includes an anodic outlet that transfers the oxygen gas produced from the electrochemical cells within the stack as well as unreacted water byproduct to further downstream components for further processing. Again, the additional downstream components following the anodic outlet are not depicted, but may include water-gas separators, purifiers, heat exchangers, circulation pumps, pressure regulators, etc.

In FIG. 3, an anodic pressure regulator is depicted at the anodic outlet. This pressure regulator may be positioned further downstream from the anodic outlet after one or more further components such as a water-gas separator or purifier but is depicted at the particular location in FIG. 3 for simplicity.

In another embodiment, an arrangement is provided with multiple cell stacks in series/parallel.

In some cases, each cell in a stack may need to accommodate two or three different streams of water flowing past the cell (e.g., water flowing on the anode side, on the cathode side, and in some cases, within a coolant stream) as well as allowing electricity to be conducted through the cell. Electrochemical systems operate under pressure (e.g., the water flows across the cells in the stack at high pressures), which means the water needs to be sealed within the stack. In one example, an electrochemical stack may operate at 10 atm or higher. Seals surrounding the cells may need to have force applied to the sealing areas to work effectively (i.e., in order to form an appropriate seal). Further, because water pressure is applied to the cells throughout the stack, there is a tendency for the entire stack to want to separate under this pressure. Thus, in order to pre-compress the seals and to hold the entire stack together during operation, the stack and individual cells need to be compressed.

In some cases, a stack may be under variable pressure. In one example, when the stack is turned off, the pressure inside the stack may decrease, which means the stack may be subjected to various pressure cycles. Reducing seal compression when the electrochemical stack is not operating, reduces the number of overall compression sets, and the seal lifetime is extended. Additionally, when pressurized, the seal compression may decrease, resulting in a reduced capacity to seal against higher pressures.

Further, in some cases, the stack may need to accommodate for thermal expansion due to thermally mismatched material. When the cell stack is introduced to different temperatures, (e.g., ambient air temperatures or different operating conditions), the materials within the cell stack may expand or compress, causing a change in pressure. This will change both the MEA and seal compression, as a result the stack may not operate efficiently or become damaged.

Uncontrolled compression of electrochemical stacks and cells leads to a number of problems, including under and over-compression of the MEA, a reduction of seal lifetime, and under and over-compression of the stack due to thermally mismatched materials.

For the cells in a stack, there may be an ideal membrane contact stress. When an MEA is under compressed, the contact resistance is high, and the performance is low. When the MEA is over-compressed, then the MEA can be damaged, and its lifetime can be shortened. Also, MEA over-compression may suppress mass transport (i.e., water to electrode, gas away from electrode). Thus, maintaining an optimal MEA compression, including the ideal membrane contact stress, during operation and throughout the lifetime of the cells and stack may be desirable.

The seal, when compressed, degrades over time and over the many compression sets. Seals may also creep after many compression sets, meaning the seals lose their original shape and become compacted or flattened. Both seal degradation and creep lead to less sealing force (i.e., the seal being able to seal less pressure) and/or leaks. Thus, managing the compression of a stack for optimal and consistent MEA and seal compression may be desirable.

Existing solutions are static electrochemical compression systems, which compress the stack once during manufacturing and then do not adjust the compression based on operating conditions or through the lifetime of the stack. This means that during operation and over the lifetime of the stack, the compression of the MEA moves away from optimal and the performance and/or lifetime of the stack is reduced. Additionally, when the seal stays compressed at all times, its lifetime is lower, or during pressurization, it is compressed less and may seal less pressure (i.e., less sealing force).

In certain commercial embodiments, compression is done using static/passive large bolt systems. These bolt systems may include long rods, bolts, or tie rods with numerous washers, such as conical spring washers (e.g., Belleville washers), stacked on one another to form a spring-like structure and attached to the rods or bolts. These bolts may be torqued to a known setting to apply a known clamp load, or flexible pre-load.

The use of Belleville washers may create a bulky solution for stack compression that may limit pressure fluctuations on the stack but does not completely eliminate the pressure fluctuations. Further, as an electrochemical stack ages, adjusting the compression in real time without direct human intervention is impossible with a passive system. Thus, a system that may uniformly compress the stack components in real time, or at least periodically, during the lifetime of the stack's operation, while using inexpensive, machined end plates, is desirable.

Static compression systems, including the large bolt system described above, problematically do not allow for a change in compression load applied to the stack to accommodate for things like thermal expansion, increased stack pressure, and seal and/or material degradation. For these reasons, static compression systems also do not allow for changing compression loads in response to thermal expansion and do not allow to adjust the compression in real time. Nor do static compression systems work well with variable pressure systems, because the compression load remains the same whether that initial pre-set compression load is needed or not.

Furthermore, in certain embodiments, compression may be achieved mechanically (e.g., using motor and gears), with hydraulics, or with compressed air/liquid bladders (described further below). However, when such compression systems are utilized the compression system must be operating constantly to secure the compression load onto the stack. Any failure in the compression system may thus result in the stack losing compression.

Therefore, as disclosed herein, an optimal or improved solution may include using a hybrid compression system that allows the compression force applied to the stack to be changed or adjusted during operation of the stack and over the lifetime of the stack.

Specifically, an optimal or improved solution may include a hybrid compression system that provides compression force onto the stack and also secures the load applied to the stack during the operation of the stack.

Such a hybrid compression system may advantageously include a first compression system configured to provide first adjustments to a compression force applied to the electrochemical stack such as to compress or decompress the electrochemical stack, and a second compression system configured to provide second adjustments to the compression force on the electrochemical stack during the steady-state operation of the electrochemical stack. As a result, the hybrid compression system not only actively activates compression but also engages only as needed, eliminating the need for redundant systems, and reducing the potential for frequent maintenance. Additionally, the hybrid compression system described herein advantageously allows plant operators to remotely decompress and/or compress an electrochemical stack during operation of the stack, therein eliminating the necessity of shutting down the plant for compression adjustments to the stack.

In certain examples, the hybrid compression may be performed mechanically (e.g., using motor and gears), hydraulically, and/or via compressed air/liquid bladders. For example, the hybrid compression system may include a hydraulic system, hydraulic nuts, roller screw mechanism/actuator, inclined planes and motors, and/or the like. Any and all types of electro-mechanical, electro-hydraulic, hydraulic, pneumatic, direct motor driven systems, rack and pinion system, and the like may be used. All types of actuators, such as hydraulic bladders, pneumatic bladders, and the like may be used. Any and all ways of creating a force that is controllable may be used to actively manage stack compression.

Optimal compression points may be determined by predetermined design specifications or by measuring operating pressure, temperature, optical measurements of stack dimensions, or measurement of other operating conditions.

The initial stack compression may be based on the force required for sealing and optimal MEA compression. Force required for sealing and optimal MEA compression are design specifications. The amount of force applied may change, however. For instance, upon pressurization of the electrochemical stack, the hydraulic or mechanical mechanism may increase stack compression force based on a pressure measurement to counter the pressure force and maintain optimal MEA compression and seal force. As the electrochemical stack heats up and hydrates, i.e., during steady-state operation, based on temperature measurements, the stack compression may be reduced to avoid MEA over compression due to the expansion of thermally mismatched material. During the steady-state operation of the electrochemical stack, the hybrid compression system can be configured to make stack adjustments and maintain stack compression without the need for constant application of pressure.

Over the operating lifetime, as some materials may flatten due to the compression sets and the stack gets shorter, the hybrid compression system may monitor these dimension changes and increase stack compression to counter the material compression set and lower MEA compression. In one example, the hybrid compression system may monitor stack height optically. In another example, various other sensors may be used. During depressurization and off periods, the hybrid compression system may reduce stack compression to avoid MEA over compression and also to lower the seal compression to extend the seal life. Maintaining optimal MEA and seal compression maximizes the performance and lifetime of the electrochemical stack and components therein, such as the seals. In another example, the hybrid compression system may provide compression force onto the stack and also secure the load applied to the stack during the operation of the stack.

### Controlling Compression in an Electrochemical Stack Via a Hybrid Control System

In one embodiment, an electrochemical stack may be pressurized by a hybrid compression system configured to adjust or fine-tune the stack pressure. The hybrid compression system may provide first adjustments to a compression force applied to the electrochemical stack such as to compress or decompress the stack during start-up and/or shutdown of the electrochemical stack. The hybrid compression system may also provide second adjustments to the compression force on the electrochemical stack during a steady-state operation of the electrochemical stack.

As used herein, the term “steady-state operation” may refer to the operation of an electrochemical stack in which the stack is not in a start-up or shutdown procedure such as when the operating parameters (e.g., pressure, temperature, flow rate) within the electrochemical stack are fixed or are not varying within a defined percentage amount over a period of time. For example, the electrochemical stack is being operated at a set pressure and/or temperature or within an identified range of the predefined setpoint pressure and/or temperature. For instance, the steady-state operation of the electrochemical stack may refer to the stack having a current operating temperature, current operating pressure, and/or current operating flow rate of hydrogen gas being produced from the stack or water being introduced to the stack that is within 25%, within 20%, within 15%, within 10%, or within 5% of a predefined setpoint temperature, pressure, and/or flow rate and not in a start-up or shutdown procedure. Alternatively, the steady-state operation of the electrochemical stack may refer to the stack having a current operating temperature, current operating pressure, and/or current operating flow rate of hydrogen gas being produced from the stack or water being introduced to the stack that is not varying by more than 5%, 10%, 15%, 20%, or 25% over a period of time (e.g., 10 minutes, 30 minutes, 1 hour, 2 hours, 4 hours, etc.)

Steady-state refers to a condition where the electrochemical system's parameters, such as pressure, temperature, and flow rate, remain constant over time. In the context of the electrochemical stack 312, steady-state operation implies that the stack 312 is operating under stable conditions without significant fluctuations in its key parameters. Thus, during the steady-state operation of the electrochemical system 301, the hybrid compression system may advantageously provide secondary adjustments to the compression force on the electrochemical stack to maintain optimal stack compression.

In this example, the hybrid compression system may include a first compression system configured to provide the first adjustments and a second, separate compression system configured to provide the second adjustments.

The first compression system may include: (1) a plurality of hydraulic cylinders or a plurality of pneumatic cylinders; and (2) at least one pressure source or hydraulic reservoir in communication with the plurality of hydraulic cylinders or the plurality of pneumatic cylinders. The first compression system may be configured to provide the first adjustments to the compressive force on the stack during start-up and/or shutdown of the electrochemical stack.

In one particular example, the first compression system may include one or more external hydraulic piston actuators. Fluid pressure may be applied to the stack components through the hydraulic compression system. This may include a pressurized bladder placed between an end plate and the stack components, though it may also be implemented as a sealed cavity. This approach provides for uniform compression pressures and completely decouples end plate stiffness and flatness from the tolerance stack up and thermal motion of the stack components relative to the compression structure.

In this example, the hybrid compression system may also include a second compression system having a motor and drivetrain. The second compression system may be configured to provide second adjustments to the compression force on the electrochemical stack during the steady state operation of the electrochemical stack.

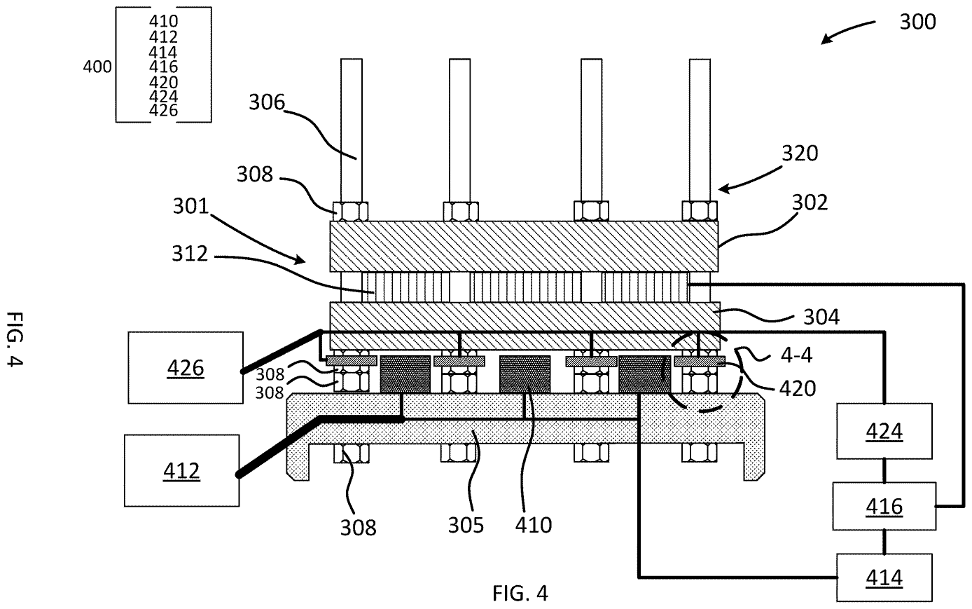

FIG. 4 depicts an example of a combined system 300 for routinely or periodically controlling stack compression using a hybrid compression system 400. The system 300, as depicted in FIG. 4, may include an electrochemical system 301 that includes an electrochemical cell stack 312 and a support structure 320 of the stack 312. The stack 312 may be an electrochemical stack and may include a plurality of individual cells.

The number of cells within the cell stack 312 is configurable. In some examples, the number of cells may be within a range of 50-1000 cells, 50-100 cells, 500-700 cells, or more than 1000 cells.

The support structure 320 for the cell stack in the electrochemical system 301 may include two end plates 302 and 304, a base 305, a plurality of tie rods or bolts 306, and a plurality of nuts or bolt heads 308 associated with the plurality of tie rods 306 (e.g., wherein the tie rods are threaded through the nuts). The two end plates may include a first end plate 302 and a second end plate 304. The first end plate 302 is positioned near the top of the stack 312 and the second end plate 304 is positioned near the bottom of the stack 312 and above the base 305. The two end plates 302 and 304, and the base 305 are configured to be coupled to the plurality of tie rods 306, such that the stack 312 is positioned between the first end plate 302 and the second end plate 304.

The end plate 302 and the base 305 are configured to be fixed by the plurality of tie rods 306 and corresponding nuts 308 such that only the end plate 304 may move with respect to the end plate 302 and the base 305. For example, as depicted in FIG. 4, the base 305 is coupled to the plurality of tie rods 306 and corresponding nuts 308. At a bottom surface of the base 305, the bottom ends of the tie rods are fixed by fastened corresponding nuts 308. Furthermore, to secure the base 305 from moving along the tie rods 306, additional corresponding nuts 308 are positioned on the top surface of the base 305 to fix the base 305 in place.

The end plate 304 is positioned above the base 305 and is configured to move along the plurality of tie rods 306. Additionally, a plurality of corresponding nuts 308 are positioned on the tie rods 306 to secure the end plate 304. These nuts 308 can be adjusted to regulate the vertical position of the end plate 304 relative to the base 305 and secure the end plate 304 from moving when the stack 312 is under a compression load.

In certain embodiments, the plurality of tie rods 306 includes at least one tie rod 306 near each corner of the system (e.g., for a total of at least four tie rods). In certain cases, additional tie rods 306 may be positioned between each corner of the system 300. In the depicted example, a total of eight tie rods 306 are positioned. Four tie rods 306 are positioned on a front side of the system 300 and four tie rods are positioned on the back side of the system 300. As depicted in FIG. 4, only four tie rods are illustrated being positioned on the front side of the system 300.

In certain examples, while not depicted in FIG. 4, instead of threading the tie rods 306 through the plurality of nuts or bolt heads 308 on one end of the tie rod 306, the tie rods 306 may be directly threaded into a taped feature in the first end plate 302 and/or base 305.

In another example, the tie rods 306 may have a bolt head configuration with one secured or fixed end and one open threaded end to receive a nut 308. In such an alternative embodiment, elements 308 depicted on the top end of the tie rods 306 in FIG. 4 would refer to fixed, unremovable ends of a bolt head, and elements 308 depicted on the bottom end of the tie rods 306 in FIG. 4 would refer to bolts fixed to the base 305. In other words, alternative forms of fixing or securing one end of a tie rod 306 may be provided instead of a nut 308 or bolt head configuration as depicted in FIG. 4.

The support structure 320 is configured to support and compress the stack 312 while under tension through an application of an external force to the end plate 304 (e.g., via a first compression system 410 described in greater detail below) and/or by tightening a plurality of nuts 308 on ends of corresponding tie rods 306 (e.g., via a second compression system 420 described in greater detail below). Likewise, the support structure 320 may expand when the external force is removed or reduced, in which case the two end plates 302 and 304 decompress. In some cases, the end plates 302 and 304 of the support structure 320 conform to the entire stack 312 which allows the external force to be applied evenly. In other words, the support structure 320 is configured to apply the external force uniformly across the entire surface of the stack 312 on which the force is applied to (e.g., through an application of force to the end plate 304). Further, the number of tie rods 306 and the arrangement of the tie rods 306 may be proportional to the size of the stack 312 to provide uniform compression. Other configurations are possible.

The system 300 depicted in FIG. 4 further includes the hybrid compression system 400. In this example, the hybrid compression system 400 may be detachably connected to the electrochemical system 301 and configured to advantageously provide updates or adjustments to the pressure on the cell stack 312 of the electrochemical system 301. As noted above, the hybrid compression system 400 may be attached to the cell stack 312 to provide adjustments or compressions on the cell stack 312 at the initial time of manufacturing of the cell stack 312, start-up of the electrochemical system 301 when the cell stack 312 is compressed, shut-down of the electrochemical system 301 when the cell stack 312 is decompressed, and/or during operation of the cell stack 312.

Specifically, periodic adjustments may be made during the operational life of the cell stack 312. For example, adjustments to the cell stack 312 may be made in real time during the steady-state operation of the cell stack 312. Thus, during the steady-state operation of the electrochemical system 301, the hybrid compression system may advantageously provide secondary adjustments to the compression force on the electrochemical stack to maintain optimal stack compression.

As depicted in FIG. 4, the hybrid compression system 400 may include a first compression system 410, a second compression system 420, a first compression controller 414 in communication with the first compression system 410, a second compression controller 424 in communication with the second compression system 420, a first power source 412, a second power source 426, and a data acquisition unit 416. In this depicted example, the first power source 412 may correspond to the first compression system 410 and the second power source 426 may correspond to the second compression system 420.

The first compression system 410 (i.e., force generating mechanism) is configured to apply an external force to the stack 312 and may include a hydraulic press or one or more hydraulic pistons, e.g., during a start-up and/or shutdown procedure of the stack. The first compression system 410 may be configured to be attached or positioned on the base 305 to apply force to the end plate 304 of the support structure 320 of the electrochemical system 301. In the depicted example, the first compression system 410 is positioned below the second plate 304 on the base 305 of the support structure 320. Force is configured to be generated by the first compression system 410 on the second plate 304 to compress the cell stack 312 positioned in between the two end plates 302 and 304 of the support structure 320. In this particular example, the force is a hydraulic compression force being supplied from a first power source 412 (e.g., a hydraulic reservoir and pump) attached to the first compression system 410.

It may be advantageous to keep the first compression system 410 only at or near the bottom of the stack for safety purposes (e.g., failures or leaks within the fluid lines coupled to the first compression system 410 would not leak into the electrochemical stack 312).

As the stack 312 expands or compresses due to thermal expansion or material wear, the first compression system 410 may be attached to the stack 312 to adjust the compression of the stack to a predefined or optimal compression.

As mentioned above, the first compression system 410 includes a first compression controller 414 in communication with the first compression system 410, sensors (not illustrated), as illustrated in FIG. 4. The first compression controller 414 may be capable of setting and changing the force applied by the first compression system 410 to the support structure 320, e.g., during the start-up or shutdown procedure. In this way, the first compression system 410 is a controllable first compression system. It may be also advantageous as the first compression force controller 414 may adjust and accommodate for load balancing.

As mentioned above, the hybrid compression system 400 also includes a second compression system 420. The second compression system 420 includes the second compression controller 424, which is in communication with the second compression system 420. The second compression system 420 may be configured to provide real-time adjustments to the compression force applied on the electrochemical stack 312 during operation of the stack. For example, once the first compression system 410 has applied a compression load onto the electrochemical stack 312, the second compression system 420 may adjust the nuts 308 positioned below the end plate 304 to move along the corresponding tie rods or bolts 306 to secure the end plate 304 from moving, and thus secure the compression load. As a result, the first compression system 410 may no longer need to operate or provide a constant load onto the stack 312, and the first compression system 410 may disengage from providing any compressive force on the stack, allowing the second compression system 420 to take over during steady-state operation of the stack.

The hybrid compression system 400 may also include a data acquisition unit 416 in communication with the first and second compression controllers 414 and 424, the electrochemical system 301, cell stack 312, plant, and/or environmental sensors. The data acquisition unit 416 may be operable to measure, monitor, and receive data from the stack 312 in real time following the attachment of the hybrid compression system 400 to the cell stack 312 and electrochemical system 301. The data acquisition unit 416 may include sensors (not illustrated) to measure, monitor, and receive system data. The system data may include plant data, environmental conditions, and/or stack data of an electrochemical stack such as pressure data, temperature data, seal data, cell and/or stack height data, gas concentration data, water data, and any other data indicative of the operating condition of the system having the electrochemical stack. In this regard, any number and types of sensors may be included in the data acquisition unit, such as pressure sensors, load sensors, temperature sensors, seal sensors, gas concentration sensors, water sensors, and optical sensors.

The data acquisition unit 416 may be in communication with the first and second compression controllers 414 and 424, such that the compression controllers 414 and 424 alter the force being applied by the first compression system 410 based on the data received by the data acquisition unit 416. In this way, compression force applied to the stack 312 may be actively managed in real time based on operating conditions of the stack 312.

In certain examples, following the collection of data such as operational pressure data of the cell stack 312 using the data acquisition unit 416, the first compression system 410 may be actuated to provide additional pressure to the support structure 320 and cell stack 312. Following the additional compression on the stack 312 via the first compression system 410, the second compression system 420 may adjust the one or more nuts 308 of the support structure 320 to be tightened to retain the adjusted compression on the cell stack 312. As a result, the first compression system 410 does not need to constantly provide the compression load, thus advantageously retaining the structural integrity of the component while reducing energy consumption and minimizing wear and tear on the system.

Alternatively, by monitoring the cell stack pressure using the attached data acquisition unit 416 of the hybrid compression system 400, it becomes possible to loosen one or more of the nuts 308 within the support structure 320 via the second compression system 420. This action relieves or decreases the pressure on the cell stack 312, enabling the first compression system 410 to either re-engage the compression load or restore the pressure to a desired or optimal operational level.

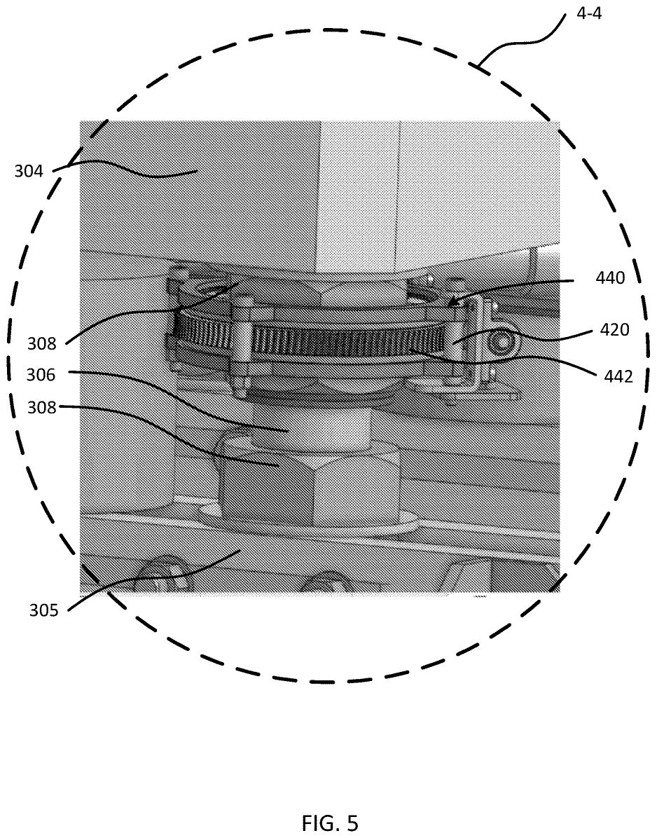

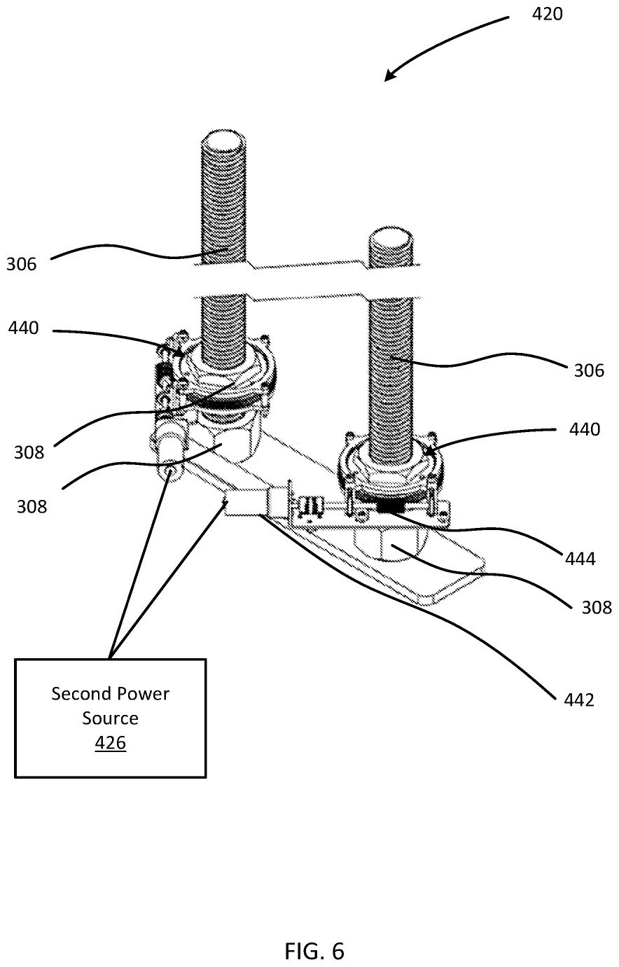

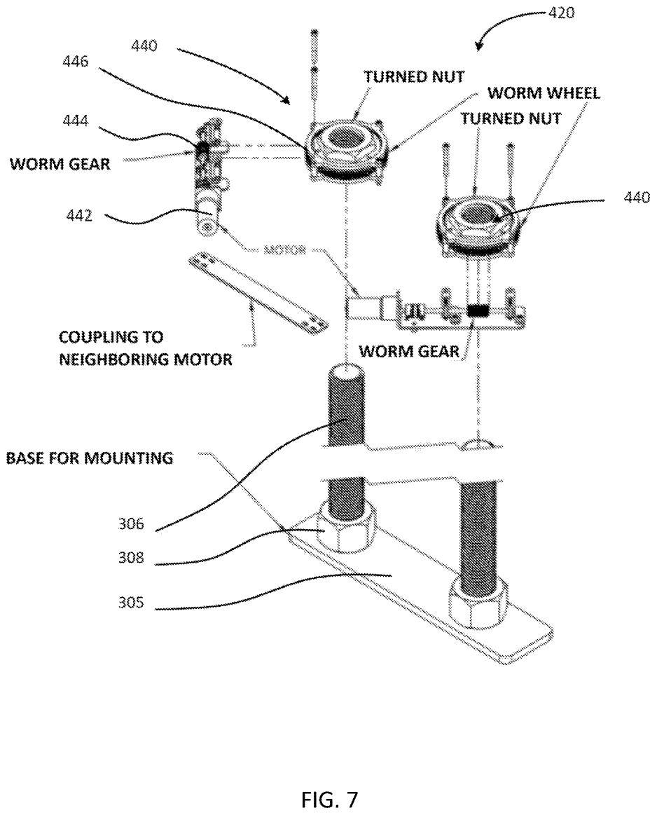

FIGS. 5-7 depict examples of a second compression system of a hybrid compression system for an electrochemical stack having a plurality of electrochemical cells. Specifically, FIG. 5 depicts section 4-4 of FIG. 4. FIG. 6 depicts an example of a second compression system including a plurality of engagement mechanisms. FIG. 7 depicts an exploded perspective view of a second compression system including a plurality of engagement mechanisms.

Referring to FIGS. 5-7, a second compression system 420 may include a plurality of engagement mechanisms 440. Each engagement mechanism 440 of the plurality of engagement mechanisms 440 is configured to adjust a nut 308 of the plurality of nuts 308 to move the nut 308 along a corresponding tie rod or bolt 306 of the support structure 320.

Each engagement mechanism 440 includes a motor 442, and a drivetrain 444. The motor 442 is configured to power the drivetrain 444. The drivetrain 444 is coupled to a respective nut 308 and configured to transfer power from the motor 442 to the nut 308 such that the nut 308 may rotate up or down a respective tie rod or bolt 306.

The motor 442 and drivetrain 444 are coupled to the support structure such as to be constrained from moving relative to the corresponding tie rod or bolt 306.

For example, each engagement mechanism 440 may adjust a corresponding nut 308 positioned below the end plate 304 to move along the corresponding tie rods or bolts 306 to secure the end plate 304 from moving, and thus secure the compression load.

In certain examples, as depicted in FIGS. 5-7, the motor 442 is a stepper motor. However, any type of motor may be used, and the disclosure is not limited to a stepper motor.

Furthermore, as depicted in FIGS. 5-7, the drivetrain 444 may include a worm gear and a worm wheel. The worm gear may be configured to be coupled to the worm wheel. The worm wheel may be coupled to a nut 308. Thus, as the motor transfers power to the worm gear, the power from the worm gear is transferred to the worm wheel, which is coupled to the nut 308, thus allowing for smooth and efficient power transmission to the nut 308. As a result, the nut 308 is configured to rotate/move (vertically) along the tie rod 306.

For example, the worm gear, driven by a motor 442, features a spiral thread akin to a screw, while the worm wheel meshes with the threads of the worm gear. Connected to the worm wheel is a nut 308, threaded onto a rod 306. As the motor 442 activates, turning the worm gear, the worm wheel rotates, converting this motion into vertical movement.

Consequently, the nut 308 travels along the threaded rod 306, effectively supporting the end plate 304.

In certain examples, the drivetrain 444 includes a spur, a bevel, a pully system, or a combination thereof. In other words, the drivetrain 444 is not limited to a worm gear and worm wheel configuration.

### Methods for Actively Controlling Stack Compression Via a Hybrid Compression System

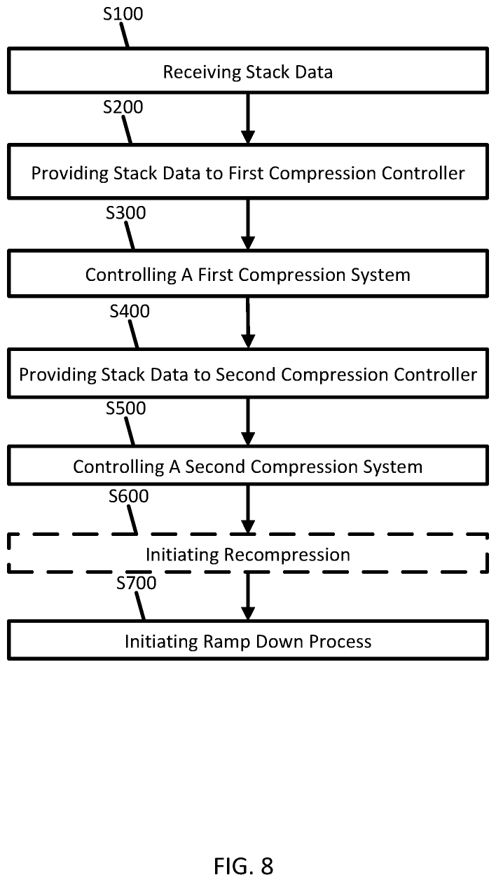

FIG. 8 depicts an example method for actively controlling stack compression (e.g., either in real time or via periodic adjustments).

In act S100, system data (e.g., plant data, environmental conditions, and/or stack data) may be received from an electrochemical stack. This system data may be obtained via a data acquisition unit configured to receive the system data. The data acquisition unit may be permanently attached to the stack or may be configured to be temporarily or removably attached to the stack. In certain examples, the system data may be received in real time. The system data may include plant data, environmental conditions, or stack data such as pressure data, temperature data, seal data, cell and/or stack height data, gas concentration data, water data, and any other data indicative of the operating condition of the plant or stack. In this regard, any number and types of sensors may be included in the data acquisition unit, such as pressure sensors, load cells, temperature sensors, seal sensors, gas concentration sensors, water sensors, and optical sensors.

In act S200, the system data may be provided, by the data acquisition unit, to a first compression controller.

In act S300, the amount of force (and the timing of the application of force) applied by a first compression system to the electrochemical stack is controlled based on the system data using the first compression controller.

In other words, in act S300, the first compression controller controls the first compression system. The first compression system is configured to provide first adjustments to a compression force applied to the electrochemical stack such as to compress the electrochemical stack during start-up. The first compression system may include: (1) a plurality of hydraulic cylinders or a plurality of pneumatic cylinders and (2) at least one pressure source or hydraulic reservoir in communication with the plurality of hydraulic cylinders or the plurality of pneumatic cylinders.

In act S400, the system data may be provided, by the data acquisition unit, to a second compression controller after the start-up of the electrochemical stack or during steady-state operation of the electrochemical system.

In act S500, the second compression controller may control the second compression system to provide second adjustments to the compression force on the electrochemical stack during the steady-state operation of the electrochemical stack. As a result, the second compression system may support the compression load applied on the electrochemical stack, and thus the operation of the first compression system may be disengaged.

For example, during the steady state operation of the electrochemical system, the second compression system may engage and secure the compression load applied on the electrochemical stack to advantageously reduce the operation of the first compression system. Thus, the first compression system may advantageously not need to constantly provide a compression load on the electrochemical stack and be disengaged from operation to save on wear and tear of the hydraulic or pneumatic components of the first compression system.

In act S600, the hybrid compression system may initiate a recompression process to recompress the electrochemical stack when a low compression/pressure threshold is detected by the acquisition unit during the steady-state operation of the electrochemical stack.

In act S700, the hybrid control system may proceed to ramp down and may initiate a ramp down process.

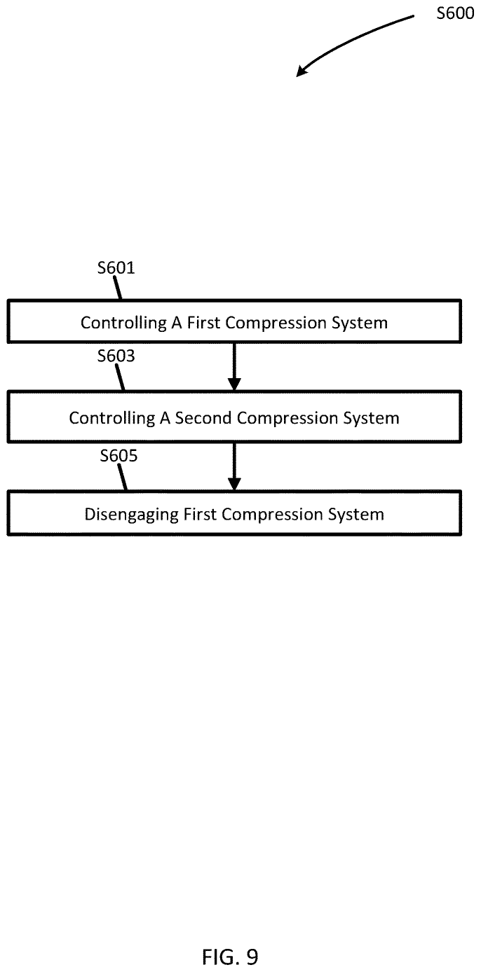

FIG. 9 depicts an example method for recompressing an electrochemical stack during steady-state operation. Acts S601-S605 describe the recompression process.

In act S601, once the recompression process is initiated, the first compression controller may control the first compression system to recompress the electrochemical stack 312.

In act S603, once the electrochemical stack is recompressed, the second compression controller may control the second compression system to support the compression load applied on the electrochemical stack. For example, the second compression controller may control the engagement mechanisms to adjust the corresponding nuts 308, which are positioned below the end plate 304, to support the end plate 304.

In act S605, the first compression controller may control the first compression system to decompress or disengage operation, thus allowing the nuts 308 positioned below the end plate 304 to support the compression load applied on the electrochemical stack.

For example, the process begins when the data acquisition unit detects a low compression load threshold, indicating the need to adjust the compression force on the electrochemical stack 312. The first compression system 410 may re-engage and begin compressing the stack 312 up to the predetermined setpoint using the hydraulic or pneumatic cylinders. If the nuts 308 holding the components together are not loose, the compression continues until either the nuts 308 loosen or a high threshold is detected, ensuring optimal compression levels. Once this is achieved, the second compression system 420 is activated. Each engagement mechanism 440 of the second compression system 420 loosens corresponding nuts 380, which are positioned beneath the end plate 304, allowing for proper adjustments. Following this, the hydraulic cylinders of the first compression system 410 return to the steady-state load setpoint (e.g., 1500 kN) ensuring stability and consistency in operation. The second compression system 420 then engages again to tighten the nuts 308 securely against the end plate 304. Once secured, the first compression system 410 disengages, allowing the nuts 308 to support the compression load applied on the electrochemical stack 312.

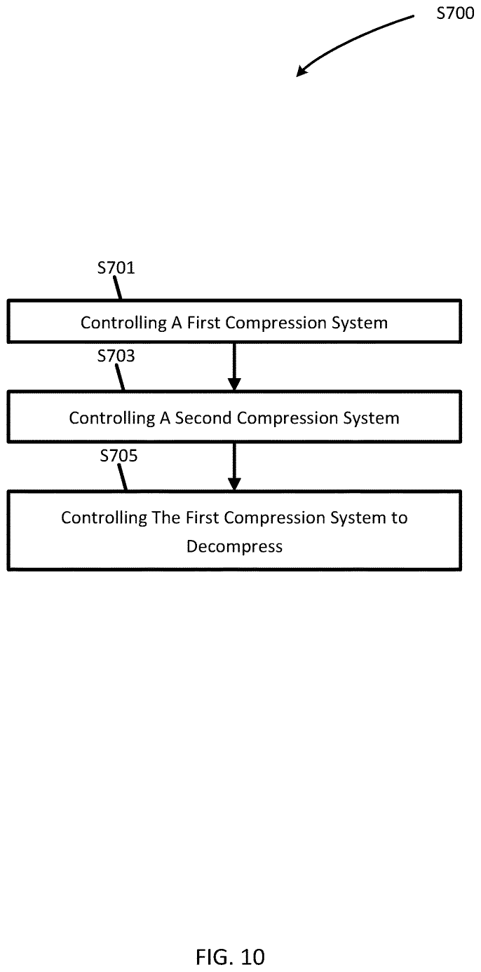

FIG. 10 depicts an example method for decompressing an electrochemical stack during a ramp-down operation. Acts S701-S705 describe the ramp-down process.

In act S701, the first compression controller may control the first compression system to recompress the electrochemical stack 312.

In act S703, once the electrochemical stack is recompressed, the second compression controller may control the second compression system to disengage.

For example, the second compression controller may control each engagement mechanism to loosen their respective nuts 308 and move the respective nuts down along their respective tie rods or bolts 306.

In act S705, the first compression controller may control the first compression system to decompress and lower the compression force applied onto the electrochemical stack.

For example, the first compression system 410 re-engages and applies pressure to the electrochemical stack 312 until reaching a designated setpoint. Should the nuts 308 remain secure, compression persists until either the nuts 308 loosen or a high threshold is detected. Upon achieving the desired compression, the second compression system 420 initiates, loosening the nuts 308, which are positioned below the end plate 304, for adjustments. The second compression system 420 may then loosen the nuts 308 such that the first compression system 410 supports the compression load. Subsequently, the first compression system 410 returns to the steady-state load setpoint, ensuring stability in operation. During the ramp-down phase, the system 400 may opt to maintain a constant load or gradually decrease pressure. While awaiting cooldown, the first compression system 410 maintains a steady load of approximately 500 kN, for example, to uphold stability. Alternatively, the first compression system 410 may reduce the compression load applied on the electrochemical stack 312, thus decompressing the stack 312.

Such an improved solution having a system that allows for actively managing stack compression in real time or periodically based on operating conditions of the stack as described herein may provide various operating advantages over conventional operating cells/stacks. For example, a hybrid compression system allows smart decisions to be made about when to choose to apply force, the amount of force to apply, and the displacement applied. Determining how much force to apply based on the operating conditions of the stack, adjusting for load balancing, and being able to smoothly control this process allows the selection of the amount of compression force based on the operating condition of the stack, which improves seal and membrane life.

Additionally, the hybrid compression system may advantageously include a first compression system configured to provide first adjustments to a compression force applied to the electrochemical stack such as to compress or decompress the electrochemical stack, and a second compression system configured to provide second adjustments to the compression force on the electrochemical stack during the steady-state operation of the electrochemical stack. As a result, the hybrid compression system not only actively activates compression but also engages only as needed, allowing the second compression system to maintain the compression load on the stack while the first compression system is inoperative. As a result, the engagement and operation of the second compression system protects against a failure to the operation of the stack if a hydraulic or pneumatic component of the first compression system fails (i.e., the second compression system advantageously prevents against the stack losing compression during operation of the stack).

Furthermore, the hybrid compression system described herein empowers plant operators to remotely decompress and recompress an electrochemical stack, eliminating the necessity to shut down the plant during recompression cycles. This is accomplished by dynamically adjusting the bottom nut via the second compression system, which can be precisely controlled using feedback from load cells measuring stack compression.

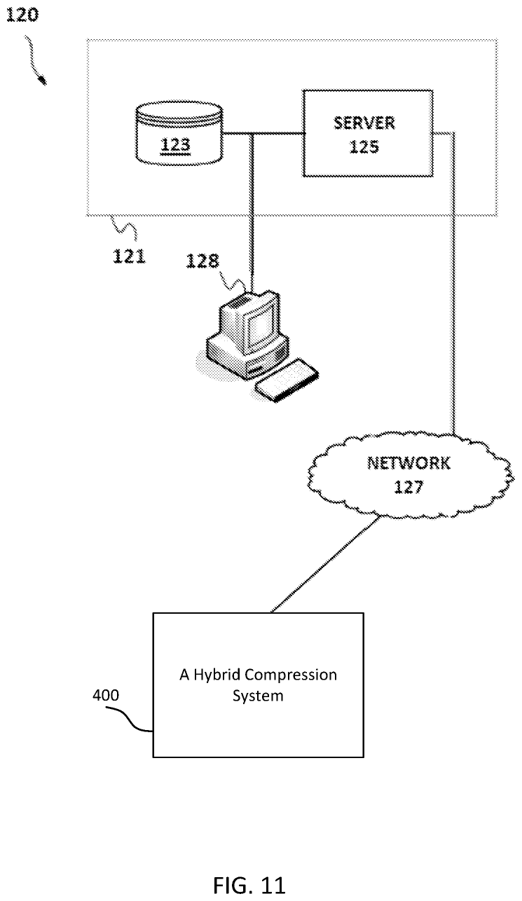

FIG. 11 illustrates an exemplary system 120 for controlling operation of an electrochemical system 301 (e.g., including controlling the hybrid compression system 400). The system 120 includes an electrochemical system 301, a hybrid compression system 400, a monitoring system 121, a workstation 128, and a network 127. Additional, different, or fewer components may be provided. In some examples, the electrochemical system 301 includes one or more of an electrochemical stack, a support structure for the stack, and a hybrid compression system, as described above in FIGS. 4-10.

The monitoring system 121 includes a server 125 and a database 123. The monitoring system 121 may include computer systems and networks of a system operator (e.g., the operator of the electrochemical system 301). The server database 123 may be configured to store information regarding the operating conditions or setpoints for optimizing the performance of the electrochemical system 301.

The monitoring system 121, the workstation 128, and the electrochemical system 301 are coupled with the network 127. The phrase “coupled with” is defined to mean directly connected to or indirectly connected through one or more intermediate components. Such intermediate components may include hardware and/or software-based components.

The optional workstation 128 may be a general-purpose computer including programming specialized for providing input to the server 125. For example, the workstation 128 may provide settings for the server 125. The workstation 128 may include at least a memory, a processor, and a communication interface.

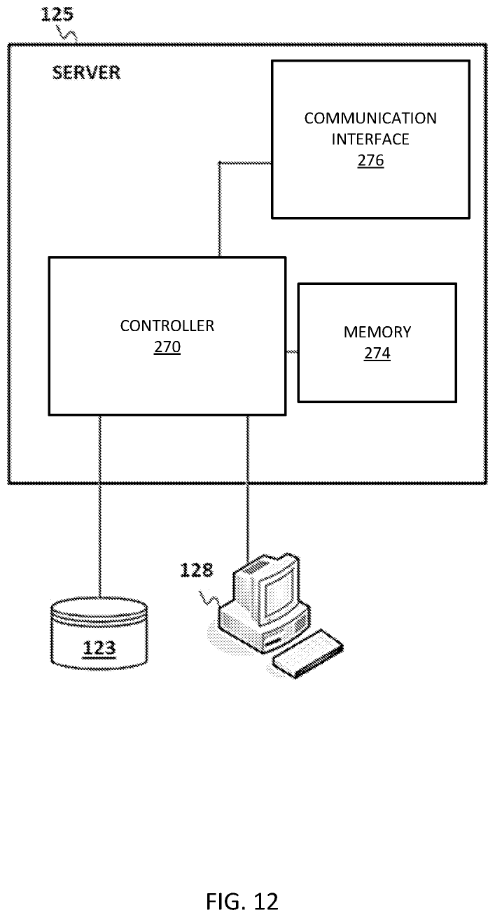

FIG. 12 illustrates an exemplary server 125 of the system of FIG. 11. The server 125 includes a memory 274, a controller or processor 270 (e.g., a first and second compression controller), and a communication interface 276. The server 125 may be coupled to a database 123 and a workstation 128. The workstation 128 may be used as an input device for the server 125. The communication interface 276 receives data indicative of use inputs made via the workstation 128 or a separate electronic device.

The controller or processor 270 (e.g., the first and second compression controllers) may include a general processor, digital signal processor, an application specific integrated circuit (ASIC), field programmable gate array (FPGA), analog circuit, digital circuit, combinations thereof, or other now known or later developed processor. The controller or processor 270 may be a single device or combination of devices, such as associated with a network, distributed processing, or cloud computing.

The controller or processor 270 may also be configured to cause the electrochemical system to: (1) control when and how much force is applied by the first compression system to the electrochemical stack; (2) control when and how much force is applied by the first compression system based on the stack data measured, monitored, and/or received by the data acquisition unit; (3) control when and how much force is applied by the second compression system to the electrochemical stack; and/or (4) control when and how much force is applied by the second compression system based on the stack data measured, monitored, and/or received by the data acquisition unit.

The memory 274 may be a volatile memory or a non-volatile memory. The memory 274 may include one or more of a read only memory (ROM), random access memory (RAM), a flash memory, an electronic erasable program read only memory (EEPROM), or other type of memory. The memory 274 may be removable from the device 122, such as a secure digital (SD) memory card.

The communication interface 276 may include any operable connection. An operable connection may be one in which signals, physical communications, and/or logical communications may be sent and/or received. An operable connection may include a physical interface, an electrical interface, and/or a data interface. The communication interface 276 provides for wireless and/or wired communications in any now known or later developed format.

In the above-described examples, the network 127 may include wired networks, wireless networks, or combinations thereof. The wireless network may be a cellular telephone network, an 802.11, 802.16, 802.20, or WiMax network. Further, the network 127 may be a public network, such as the Internet, a private network, such as an intranet, or combinations thereof, and may utilize a variety of networking protocols now available or later developed including, but not limited to TCP/IP based networking protocols.

While the non-transitory computer-readable medium is described to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting example, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative example, dedicated hardware implementations, such as application specific integrated circuits, programmable logic arrays and other hardware devices, can be constructed to implement one or more of the methods described herein. Applications that may include the apparatus and systems of various examples can broadly include a variety of electronic and computer systems. One or more examples described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

Although the present specification describes components and functions that may be implemented in particular embodiments with reference to particular standards and protocols, the claim scope is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term “circuitry” or “circuit” refers to all of the following: (a)hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any digital computer. A processor may receive instructions and data from a read only memory or a random-access memory or both. The essential elements of a computer are a processor for performing instructions and one or more memory devices for storing instructions and data. The computer may also include or may be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media, and memory devices, including by way of example semiconductor memory devices, e.g., E PROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube), LCD (liquid crystal display), or LED (light emitting diode) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server may be remote from each other and typically interact through a communication network. The relationship of client and server arises by virtue of computer programs running on the respective computers and having a client-server relationship with each other.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

1. A hybrid compression system for an electrochemical stack having a plurality of electrochemical cells, the hybrid compression system comprising:
a first compression system configured to provide first adjustments to a compression force applied to the electrochemical stack such as to compress or decompress the electrochemical stack, wherein the first compression system includes: (1) a plurality of hydraulic cylinders or a plurality of pneumatic cylinders, and (2) at least one pressure source or hydraulic reservoir in communication with the plurality of hydraulic cylinders or the plurality of pneumatic cylinders; and
a second compression system configured to provide second adjustments to the compression force on the electrochemical stack, wherein the first compression system is configured to provide the first adjustments to the compressive force during start-up and/or shutdown of the electrochemical stack, wherein the first compression system is configured to disengage from providing the first adjustments during a steady-state operation of the electrochemical stack, and wherein the second compression system is configured to provide the second adjustments during the steady-state operation of the electrochemical stack.

2. The hybrid compression system of claim 1, further comprising:
a second compression controller in communication with the second compression system, the second compression controller configured to control the compression force on the electrochemical stack; and
a data acquisition unit in communication with the electrochemical stack and the second compression controller,
wherein the data acquisition unit is operable to measure, monitor, and/or receive operational data of the electrochemical stack in real time, and
wherein the second compression controller is configured to control the compression force on the electrochemical stack in real time based on the operational data measured, monitored, and/or received by the data acquisition unit.

3. The hybrid compression system of claim 1, further comprising:
a first compression controller in communication with the first compression system, the first compression controller is configured to control the plurality of hydraulic cylinders or the plurality of pneumatic cylinders such that the compression force is applied to a support structure coupled to the electrochemical stack; and
a data acquisition unit in communication with the electrochemical stack and the first compression controller,
wherein the data acquisition unit is operable to measure, monitor, and/or receive operational data of the electrochemical stack in real time, and
wherein the first compression controller is configured to control the compression force on the electrochemical stack in real time based on the operational data measured, monitored, and/or received by the data acquisition unit.

4. The hybrid compression system of claim 3, wherein the support structure comprises:
a first end plate; and
a second end plate, wherein the electrochemical stack is positioned in between the first end plate and the second end plate;
a plurality of tie rods or bolts, each tie rod or bolt configured to be positioned through a respective opening of the first end plate and a respective opening of the second end plate to assist in securing the electrochemical stack between the first end plate and the second end plate; and
a plurality of nuts associated with the plurality of tie rods or bolts, wherein each tie rod or bolt is threaded through respective nuts of the plurality of nuts on each end of a respective tie rod or bolt,
wherein the first compression system is configured to be positioned adjacent to either the first end plate or the second end plate of the support structure, and
wherein the first compression system applies the compression force onto the first end plate or the second end plate.

5. The hybrid compression system of claim 2, wherein the data acquisition unit comprises load sensors, pressure sensors, temperature sensors, seal sensors, gas concentration sensors, water sensors, and/or optical sensors.

6. The hybrid compression system of claim 1, further comprising:
a support structure having:
a first end plate; and
a second end plate, wherein the electrochemical stack is positioned in between the first end plate and the second end plate;
a plurality of tie rods or bolts, each tie rod or bolt configured to be positioned through a respective opening of the first end plate and a respective opening of the second end plate to assist in securing the electrochemical stack between the first end plate and the second end plate; and
a plurality of nuts associated with the plurality of tie rods or bolts, wherein each tie rod or bolt is threaded through respective nuts of the plurality of nuts on each end of a respective tie rod or bolt,
wherein the second compression system comprises a plurality of engagement mechanisms, and
wherein each engagement mechanism of the plurality of engagement mechanisms is configured to adjust a nut of the plurality of nuts to move the nut along a corresponding tie rod or bolt of the plurality of tie rods or bolts to support either the first end plate or the second end plate.

7. The hybrid compression system of claim 6, wherein each engagement mechanism of the plurality of engagement mechanisms comprises a motor and a drivetrain, wherein the motor is configured to power the drivetrain, and wherein the drivetrain is coupled to a respective nut and configured to transfer power from the motor to the nut such that the nut may rotate up or down a respective tie rod or bolt.

8.-9. (canceled)

10. The hybrid compression system of claim 7, wherein the motor and the drivetrain are coupled to the support structure and configured to be constrained from moving relative to the corresponding tie rod or bolt.

11. A method of actively managing an electrochemical stack compression with a hybrid compression system comprising a first compression system and a second compression system, the method comprising:
providing, by the first compression system, first adjustments to a compression force applied to an electrochemical stack of an electrochemical system such as to compress and/or decompress the electrochemical stack during a start-up of the electrochemical stack, wherein the first compression system includes: (1) a plurality of hydraulic cylinders, or a plurality of pneumatic cylinders, and (2) at least one pressure source or hydraulic reservoir in communication with the plurality of hydraulic cylinders, or the plurality of pneumatic cylinders;
disengaging the first compression system from providing the first adjustments after the electrochemical system has reached a predefined steady-state operation;
receiving, by a data acquisition unit of the electrochemical system, stack data in real time from the electrochemical stack of the electrochemical system; and
providing, by the second compression system separate from the first compression system, second adjustments to the compression force on the electrochemical stack during the predefined steady-state operation of the electrochemical stack.

12. A method of actively managing an electrochemical stack compression with a hybrid compression system comprising a first compression system and a second compression system, the method comprising:
receiving, by a data acquisition unit of an electrochemical system, stack data in real time from an electrochemical stack of the electrochemical system;
providing, by the second compression system, adjustments to a compression force on the electrochemical stack during a predefined steady-state operation of the electrochemical stack;
engaging the first compression system that is separate from the second compression system when the electrochemical system has received instructions for a shutdown of the electrochemical stack, wherein the first compression system includes: (1) a plurality of hydraulic cylinders, or a plurality of pneumatic cylinders, and (2) at least one pressure source or hydraulic reservoir in communication with the plurality of hydraulic cylinders, or the plurality of pneumatic cylinders; and
providing, by the first compression system, adjustments to a compression force applied to the electrochemical stack of the electrochemical system such as to compress and/or decompress the electrochemical stack during the shutdown of the electrochemical stack.

13. The method of claim 12, wherein the stack data comprises load data, pressure data, temperature data, seal data, stack height data, gas concentration data, water data of the electrochemical stack, or a combination thereof.

14. The method of claim 12, wherein at least one compression controller controls the plurality of hydraulic cylinders or pneumatic cylinders such that the compression force is applied to a support structure coupled to the electrochemical stack.

15. (canceled)

16. The method of claim 12, wherein at least one compression controller controls the compression force on the electrochemical stack via a support structure.

17. The method of claim 16, wherein the support structure comprises:
a first end plate; and
a second end plate, wherein the electrochemical stack is positioned in between the first end plate and the second end plate;
a plurality of tie rods or bolts, each tie rod or bolt configured to be positioned through a respective opening of the first end plate and a respective opening of the second end plate to assist in securing the electrochemical stack between the first end plate and the second end plate; and
a plurality of nuts associated with the plurality of tie rods or bolts, wherein each tie rod or bolt is threaded through respective nuts of the plurality of nuts on each end of a respective tie rod or bolt,
wherein the second compression system comprises a plurality of engagement mechanisms, and wherein each engagement mechanism of the plurality of engagement mechanisms adjusts a nut of the plurality of nuts to move the nut along a corresponding tie rod or bolt of the plurality of tie rods or bolts to support either the first end plate or the second end plate.

18. The method of claim 17, further comprising:
controlling, by the at least one compression controller, each engagement mechanism of the plurality of engagement mechanisms to adjust a respective nut of the plurality of nuts to move the nut along a corresponding tie rod or bolt of the plurality of tie rods or bolts to engage with either the first end plate or the second end plate; and
controlling, by the at least one compression controller, each engagement mechanism of the plurality of engagement mechanisms to adjust the respective nut of the plurality of nuts to move the nut along a corresponding tie rod or bolt of the plurality of tie rods or bolts to disengage with either the first end plate or the second end plate.

19.-23. (canceled)

24. The method of claim 11, wherein the stack data comprises load data, pressure data, temperature data, seal data, stack height data, gas concentration data, water data of the electrochemical stack, or a combination thereof.

25. The method of claim 11, wherein at least one compression controller controls the plurality of hydraulic cylinders or pneumatic cylinders such that the compression force is applied to a support structure coupled to the electrochemical stack.

26. The method of claim 11, wherein at least one compression controller controls the compression force on the electrochemical stack via a support structure.

27. The method of claim 26, wherein the support structure comprises:
a first end plate; and
a second end plate, wherein the electrochemical stack is positioned in between the first end plate and the second end plate;
a plurality of tie rods or bolts, each tie rod or bolt configured to be positioned through a respective opening of the first end plate and a respective opening of the second end plate to assist in securing the electrochemical stack between the first end plate and the second end plate; and
a plurality of nuts associated with the plurality of tie rods or bolts, wherein each tie rod or bolt is threaded through respective nuts of the plurality of nuts on each end of a respective tie rod or bolt,
wherein the second compression system comprises a plurality of engagement mechanisms, and
wherein each engagement mechanism of the plurality of engagement mechanisms adjusts a nut of the plurality of nuts to move the nut along a corresponding tie rod or bolt of the plurality of tie rods or bolts to support either the first end plate or the second end plate.

28. The method of claim 27, further comprising:
controlling, by the at least one compression controller, each engagement mechanism of the plurality of engagement mechanisms to adjust a respective nut of the plurality of nuts to move the nut along a corresponding tie rod or bolt of the plurality of tie rods or bolts to engage with either the first end plate or the second end plate; and
controlling, by the at least one compression controller, each engagement mechanism of the plurality of engagement mechanisms to adjust the respective nut of the plurality of nuts to move the nut along a corresponding tie rod or bolt of the plurality of tie rods or bolts to disengage with either the first end plate or the second end plate.
